(19) United States
(12) Patent Application Publication
(10) Pub. No.: US 2007/0022020 A1
(43) Pub. Date: Jan. 25, 2007

(54) Computer implemented display having an integrated format

(76) Inventor: Daniel Benjamin Bernstein, Chicago, IL (US)

Correspondence Address: SEYFARTH SHAW LLP, 131 S. DEARBORN ST., SUITE2400, CHICAGO, IL, 60603-5803, US

(21) Appl. No.: 11/492,664

(22) Filed: Jul. 25, 2006

Related U.S. Application Data
(60) Provisional application No. 60/701,882, filed on Jul. 25, 2005.

(51) Int. Cl. G06Q 30/00; G07F 7/00

(52) U.S. Cl. 705/26; 705/27

(57) ABSTRACT

A computer implemented system for organizing information is provided that comprises a product data area for aggregating data for products, a completed order area for collecting the product data for multiple products and providing options for handling the products as a completed order and providing completed order data, a delivery area for determining delivery options for the completed order and providing delivery data, an order tracking area for tracking the completed order and providing order tracking data and a display system for displaying each of the product data, completed order data, delivery data and tracking data substantially in an integrated format. In an embodiment the system may provide for an integrated format that includes data transfer means for processing data collectively from the each of the product data, completed order data, delivery data and tracking data and displaying all such data in a single page format. In an embodiment the system may provide for an integrated format that provides for a display of data so that during selection of the data, each previously selected piece of data may be continuously displayed during selection and display of subsequent data. In an embodiment the system may provide for an integrated format that allows for display of data in a plurality of window panes and where an integrated sequence of inputs may be processed without destroying previously selected data. In an embodiment the system may provide for a product data area that includes a product search engine which allows for the searching of multiple products from a database by category.

This application claims priority to co-pending provisional patent application Ser. No. 60/701,882 filed Jul. 25, 2005.

A portion of the disclosure of this patent document including the drawing figures and screen shots contains material that is subject to copyright protection. The copyright owner has no objection to anyone reproducing the patent disclosure as it appears in the Patent and Trademark Office patent files or records. However, the copyright owner strictly reserves all other copyrights.

### BACKGROUND OF THE INVENTION

This invention relates generally to a computer implemented display having an integrated format and allows a person to more easily interact with a computer system when shopping and buying products from a store over a communications network. Moreover it pertains specifically to such apparatus for software interface design and information architecture of all steps involved for a customer to search database 125 inventory, visually browse through large numbers of images of products quickly and easily compare several product detail pages and then purchase products by submitting payment and completing a payment transaction on one page.

Web pages on the Internet for allowing for purchase of products have become well known and are implemented in different ways by various Internet retailers. Many of these sites use a shopping cart which is a means of collecting all of the items that are being purchased while the user is browsing the site when multiple items are being collected. The shopping cart, similar to a brick and mortar store, can be taken to checkout when the user has completed her shopping on the web site. There has been concern focused on the abandonment of the shopping carts. Reasons for Abandonment of shopping carts indicates why online shoppers fail to complete their purchases. Such shopping cart abandonment rates are one of the main reasons why Internet retailers believe that sales of products from their web sites are not being completed. Some studies indicate that an average online retailer fails to convert 97% of their site shoppers into site buyers. And as many as 75% of the potential customers abandoned their online shopping carts before they have consummated a purchase. Some of the reasons for shopping cart abandonment are high shipping costs, frustration of online users who have to refresh screens continuously and use the “back” button in order to find the information needed. Another element that adds to customer frustration is the length of time in order to complete the entire shopping process and the number of input operations or clicks of a mouse that it takes to complete a purchase. Some studies have shown that the average checkout process takes approximately 4.93 clicks to complete and this is seen as too many input operations for the customer that leads to frustration and loss of sales. Therefore, it is one object of the present invention to overcome the deficiencies of previous online web sites and to provide a system for making the purchase process more efficient and lower the level of frustration for users.

### SUMMARY OF THE INVENTION

In view of the limitations now present in the prior art, the present invention provides for a computer implemented system for organizing information in a computer comprising a product data area for aggregating data for products, a completed order area for collecting the product data for multiple products and providing options for handling the products as a completed order and providing completed order data, a delivery area for determining delivery options for the completed order and providing delivery data, an order tracking area for tracking the completed order and providing order tracking data and a display system for displaying each of the product data, completed order data, delivery data and tracking data substantially in an integrated format.

In an embodiment the system may provide for an integrated format that includes data transfer means for processing data collectively from the each of the product data, completed order data, delivery data and tracking data and displaying all such data in a single page format. In an embodiment the system may provide for an integrated format that provides for a display of data so that during selection of the data, each previously selected piece of data may be continuously displayed during selection and display of subsequent data. In an embodiment the system may provide for an integrated format that allows for display of data in a plurality of window panes and where an integrated sequence of inputs may be processed without destroying previously selected data. In an embodiment the system may provide for a product data area that includes a product search engine which allows for the searching of multiple products from a database 125 by category.

In an embodiment the system may provide for a product search engine that includes a keyword search function. In an embodiment the system may provide for a product data area that includes a product search engine which includes a cascading menu search depicting multiple products searched from a database 125. In an embodiment the system may provide for an integrated format that allows for completing an order by a computer enabled system by providing completed order data, delivery data and order tracking data with four or fewer input actions. In an embodiment the system may provide for a product data area that displays search results by loading product images and allowing the customer to view images propagated in a window pane depicting the search results in a horizontal row. In an embodiment the system may provide for a product data area that includes a product detail section which includes horizontally arrayed product tabs which designate individual products that allows users to toggle between the product tabs so that the customer may implement customer action options.

In an embodiment the system may provide for a completed order area that includes a shopping cart window pane, a shipping information window pane and a payment information window pane each accessible from a browser. In an embodiment the system may provide for an order tracking area that includes an open order function and an order delivered function in order to display the status of the product to be delivered. In an embodiment the system may provide for each of the completed order area, delivery area and order tracking area that are maintained on a computer server which is connected via the Internet to an end user's computer which displays the product data, completed order data, delivery data and order tracking data on a single page so that the end user may view all of such data by scrolling up or down the same page. In an embodiment the system may provide for a product data that is displayed in a first window pane, the completed order data is displayed in a second window pane, the delivery data is displayed in a third window pane and the order tracking data is displayed in a fourth window pane and the modification of data in one of the first, second, third or fourth window panes may affect the modified display of data in one of the first, second, third or fourth window panes without requiring the computer to refresh the display or destroy a previous display.

Another embodiment of the invention provides for a page information display method for displaying electronic information including the steps of displaying product data in a first window pane, displaying completed order data in a second window pane, displaying delivery data in a third window pane, displaying order tracking data in a fourth window pane and displaying the first, second, third and fourth window panes on a single page and providing for integration of each of the first, second, third and fourth window panes so that data entered into one of the first, second, third or fourth window panes may automatically be updated in one of the other of the first, second, third or fourth window panes without requiring the display to be refreshed. In an embodiment the product data area may be filled with data by displaying a scrollable horizontal display of multiple product images. In an embodiment the product data area may display information from the product image area by displaying a single product including product details and above the product detail area including multiple tabs that correspond to the multiple product data images displayed in the first window pane. In an embodiment the integrated format may provide for the step of collapsing each of the window panes into a single line including a header which may be activated in order to expand each of the first, second, third and fourth window panes. In an embodiment the first pane may include multiple cascading windows which may be opened in order to display product details.

A further embodiment of the invention may provide for a machine-readable medium having data stored thereon representing sequences of instructions which, when executed by a computing device, causes said computing device to process a customer purchase request over a computer network by performing the steps of receiving an online selection request for a first item over the computer network, retrieving pre-stored product data from a database 125, generating a product data description in a first window pane, retrieving delivery data relating to the product, generating a delivery data display area in a second window pane, retrieving order tracking data from a database 125, displaying the delivery data in a third window pane and integrating the window panes in order to provide for a system that allows for updating of data in one of the first, second or third window panes without requiring the displayed page to be reformatted.

### BRIEF DESCRIPTION OF THE DRAWINGS

For the purpose of facilitating an understanding of subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a flow diagram of the functional components of the present invention;

FIG. 2 is a flow diagram of the product search functionality of the present invention;

FIG. 3 is a flow diagram of the search results functionality of the present invention;

FIG. 4 is a flow diagram of the products detail functionality of the present invention;

FIG. 5 is a flow diagram of the checkout functionality of the present invention;

FIG. 6 is a flow diagram of the order tracking functionality of the present invention;

FIG. 7 is a exploded section view illustrating a screen shot of the cascading memory search functionality of the present invention;

FIG. 8 is a exploded sectional view illustrating a screen shot of the product thumbnail images functionality of the present invention;

FIG. 9 is an alternate view of the product thumbnail of FIG. 8 showing alternate functionality;

FIG. 10 is an enlarged section view illustrating a screen shot of the product detail functionality of the present invention;

FIG. 11 is an enlarged sectional view illustrating a screen shot of the checkout functionality of the present invention;

FIG. 12 is an enlarged sectional view illustrating a screen shot of the order tracking functionality of the present invention;

FIG. 13 is a screen shot view of a one page purchase format illustrating a detailed view of its application with all sections expanded;

FIG. 14 is an enlarged sectional view illustrating a screen shot of the footer of the page of FIG. 13;

FIG. 15 is an illustration of a screen shot of an alternate embodiment of an integrated page format as shown in FIG. 13;

FIG. 16 is an illustration of a one page purchase format similar to FIG. 13 but illustrated with all the sections collapsed by the user according to the present invention; and

FIG. 17 is a high level illustration of the components of the present invention depicting the system architecture.

### DETAILED DESCRIPTION

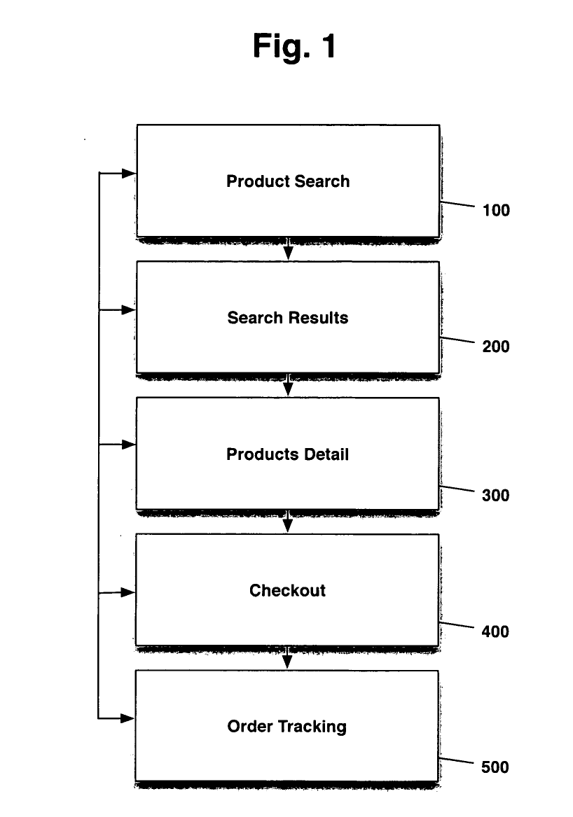

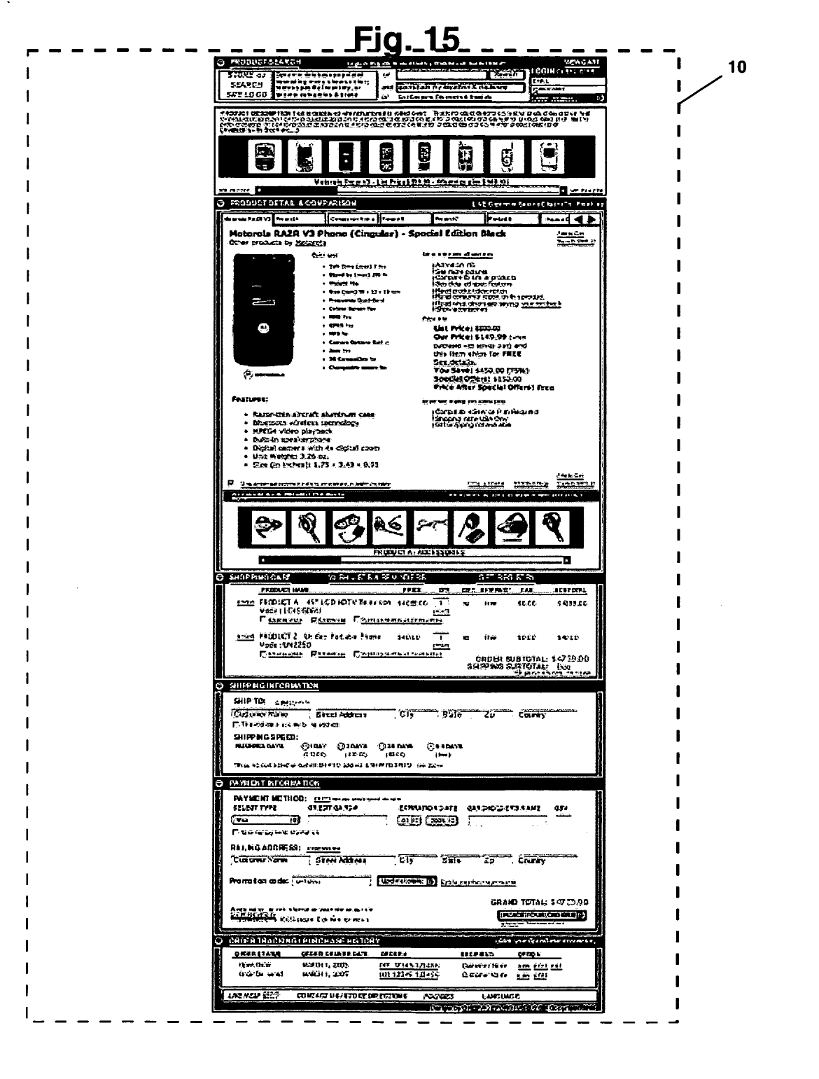

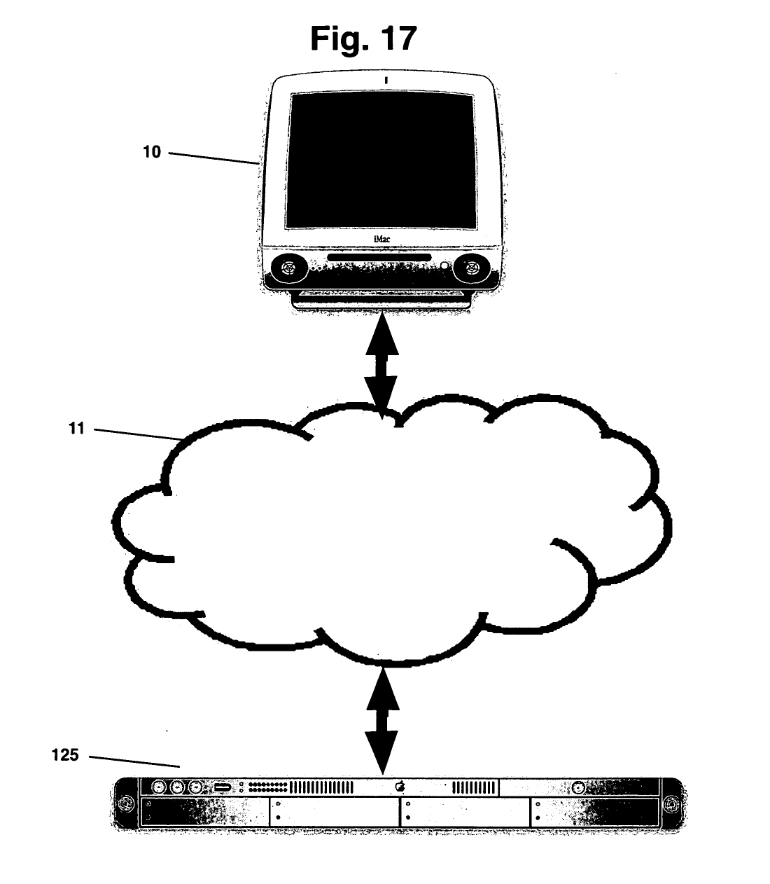

FIGS. 1-17 depict embodiments of the invention. FIG. 1 depicts the relationship of all the major steps or components required in an online shopping application in which all components are displayed and available to a user in this integrated format on a single page presented and interacted with by a user on a computer screen. An example of a one page purchase format 10 is depicted in FIG. 15. FIG. 17 depicts some of the hardware and software components of an embodiment of the present invention.

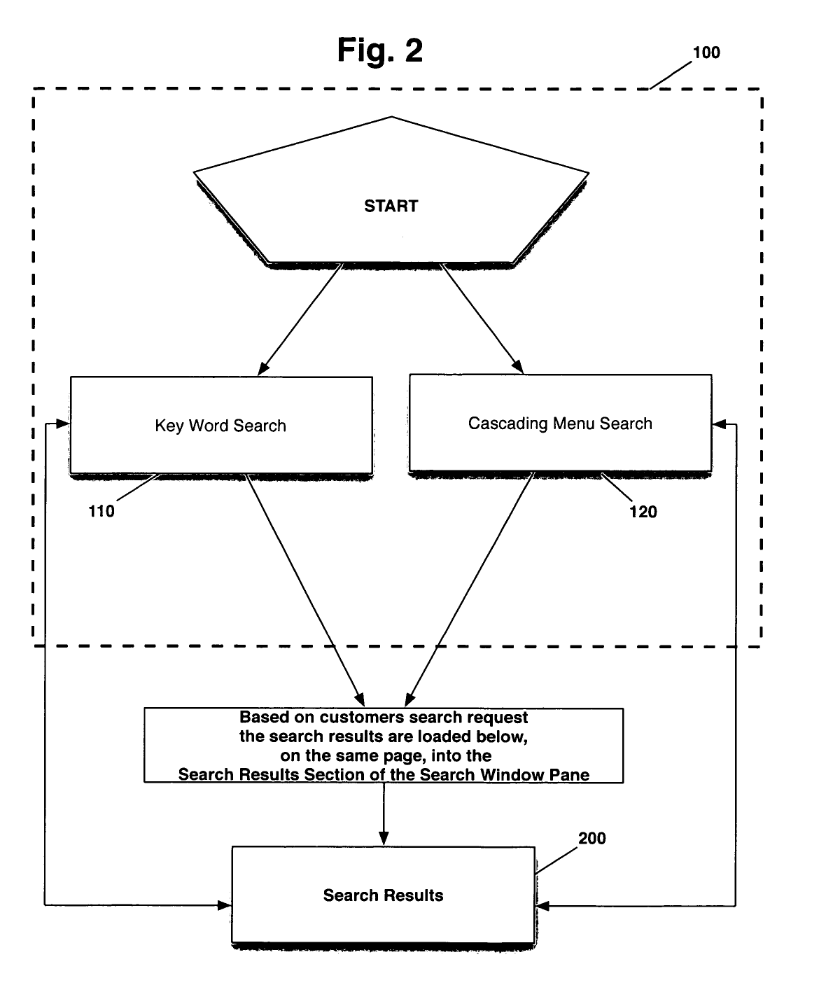

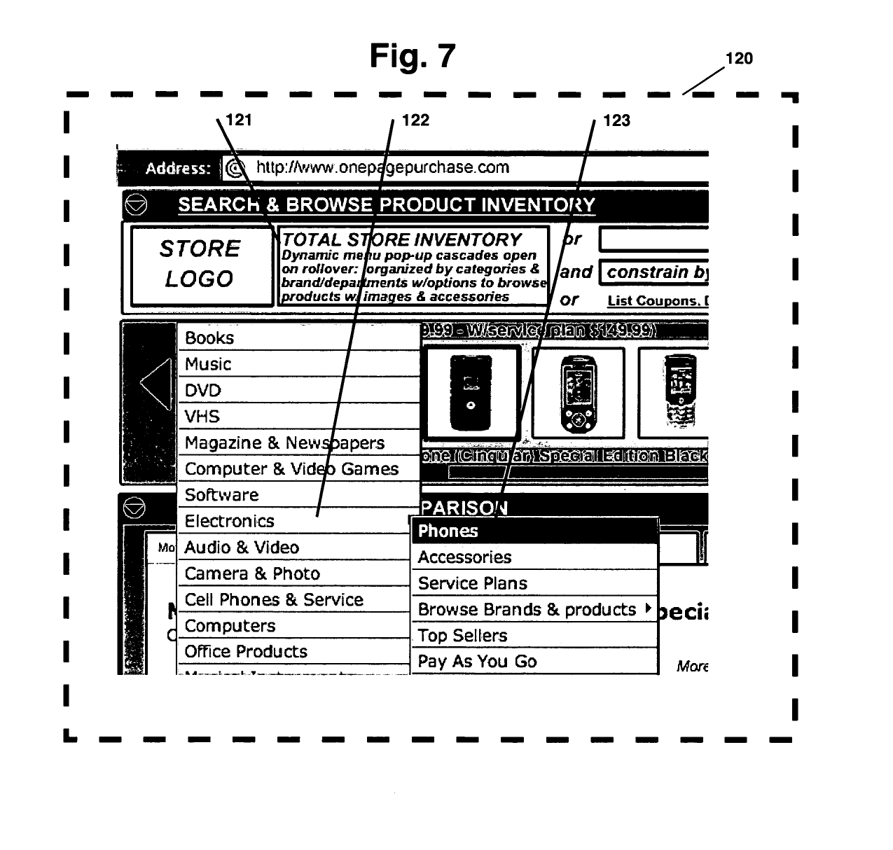

FIG. 1 depicts Product Search 100, Search Results 200, Products Detail 300, Checkout 400 and Order Tracking 500 functions of the present invention. Product Search 100 provides a search section that is defined to provide a variety of ways to begin a search for products. FIG. 2 depicts the components of a Product Search 100. Key Word Search 110 depicts a product search component that contains a search field; i.e. google, yahoo, etc. and is available for free form text searching of images; i.e. products, people, etc. Cascading Menu Search 120 depicts an alternate search method provided in the product search section. For example, shown in detail in FIG. 7, is a cascading menu, populated by a database 125 (see FIG. 17). Search Results 200 are displayed at this point in the ordering process when a customer action initiates a search of the database 125 by either submitting a Key Word Search or by selecting from the cascading menu search a super-set, Category, sub-category or specific product.

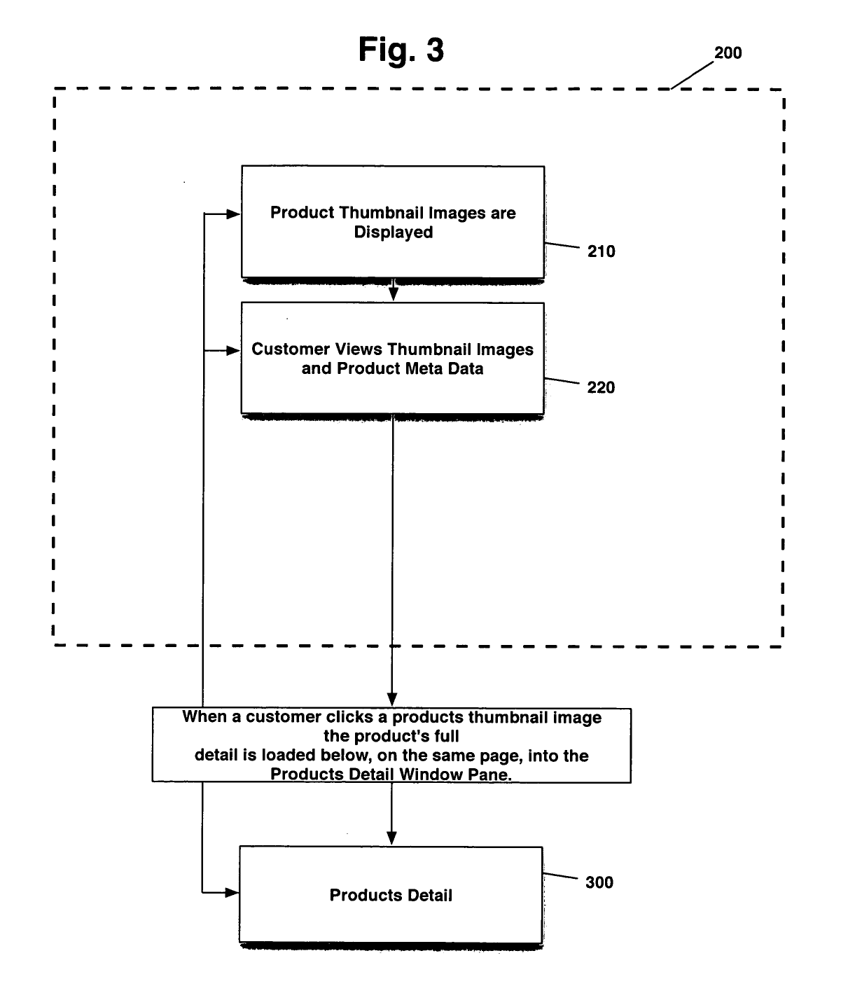

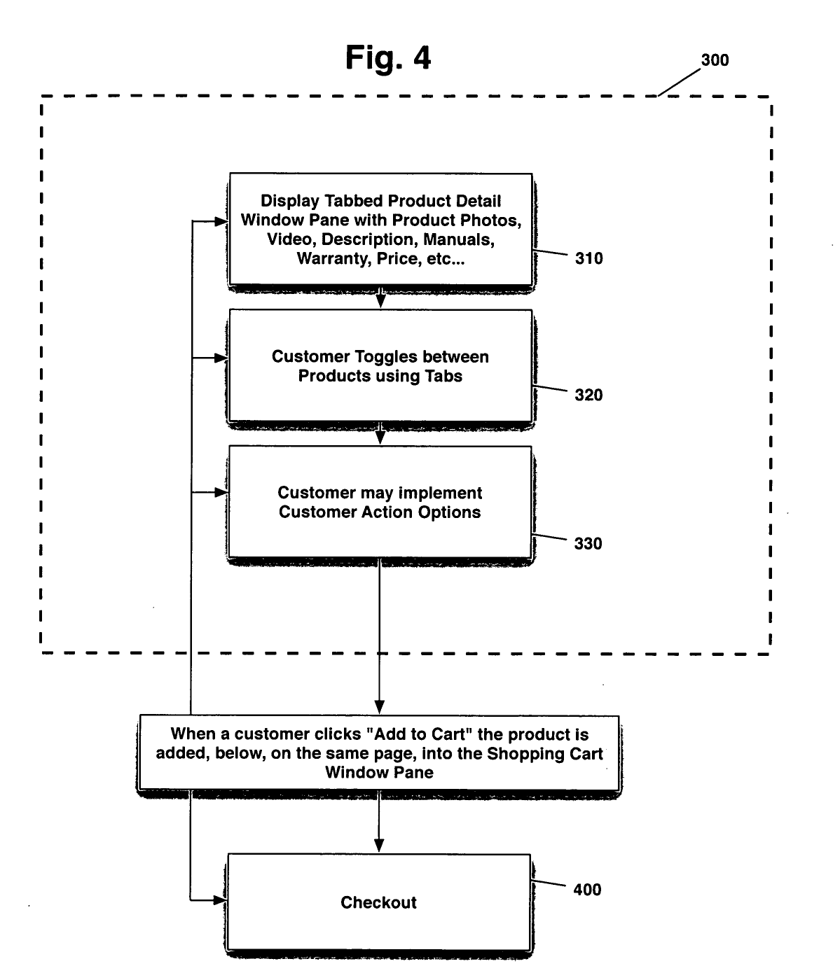

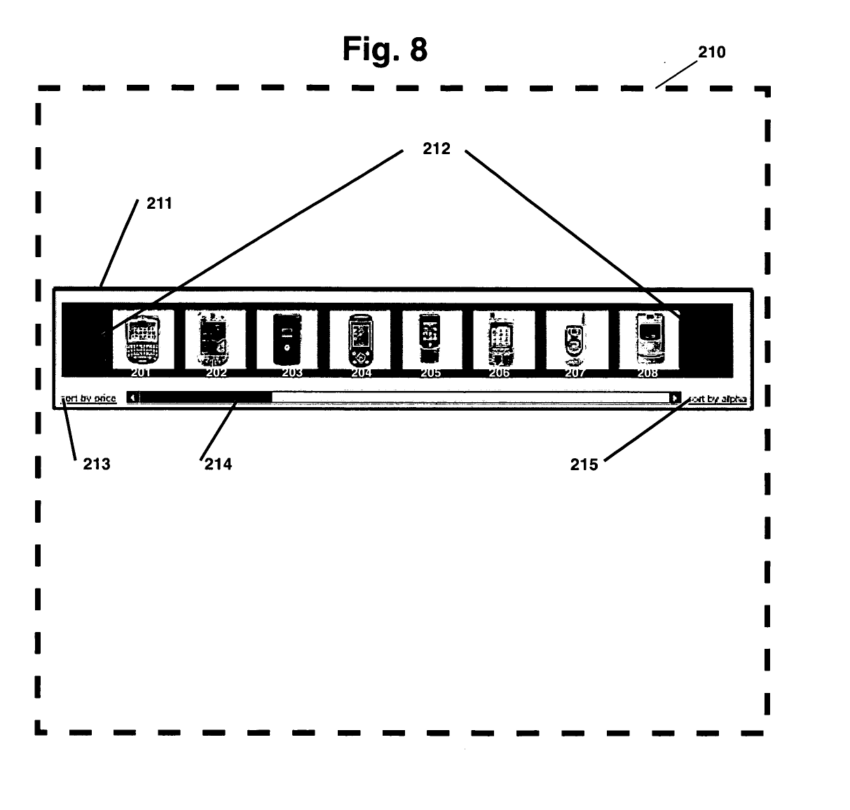

Turing to FIG. 3, Search Results 300 are the next step where the functions here contain 2 key processes. At step 210 the system pulls from the database 125 and loads the results. At step 220 the customer views the results and decides for what products they want more information. Product Thumbnail Images 210 are called from a database 125 and loaded. The search results are returned and displayed on the screen as thumbnail images that then are loaded into a Horizontal Browser (See detail in FIG. 8.) Customer Views Thumbnail Images and Product Meta Data at step 220. Meta data 221 is associated with each thumbnail and is displayed when the mouse is moved over a thumbnail image, or when the system is set to scroll automatically. When a customer clicks a products thumbnail image the product's full detail is loaded below, on the same page, into the Products Detail Window Pane (see FIG. 4, 10, 13, 15).

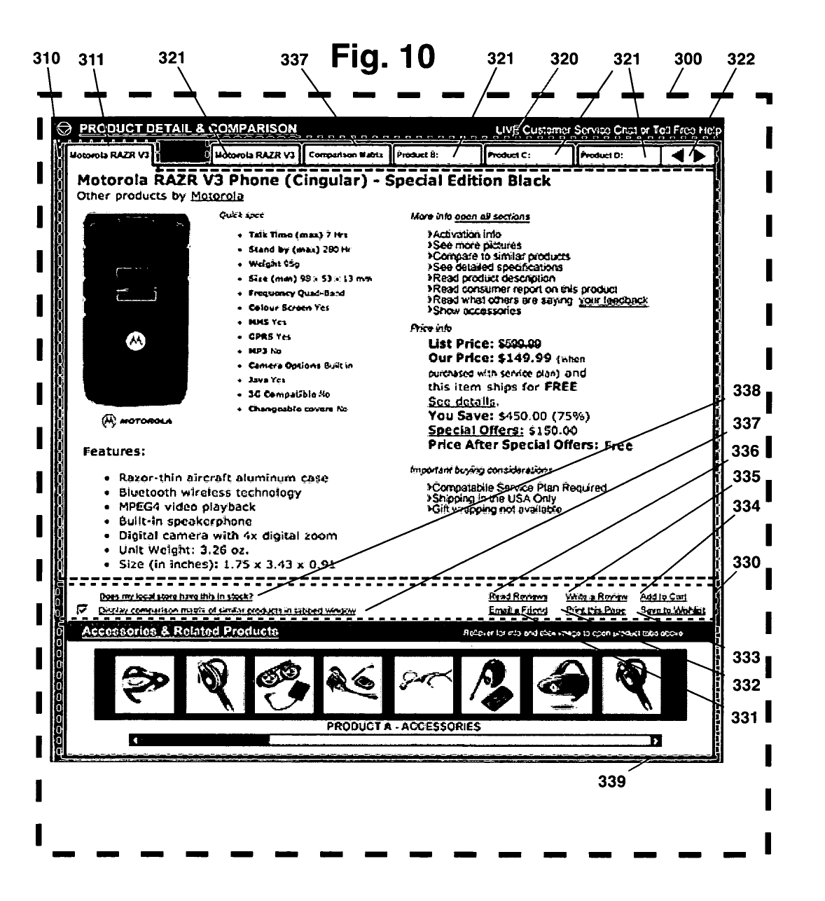

As shown in FIG. 4 Products Detail Window Pane 300 is depicted. The component described here has three major key aspects including 310 display products detailed data, 320 The ability to shuttle between products using tabs in a scrolling window, and 330 Actions the customer has the option to use. (see FIG. 10). Display Tabbed Product Detail Window Pane 310 includes Product Photos, Videos, Description, Manuals, Warranty, Price, etc . . . All of the products data is pulled from the database 125 and displayed for the customer to review in a the main area of the Product Detail Window Pane along with its own tab on a page that can expand as needed, typically vertically down the page, to display all of the products photos descriptions, etc . . . The customer toggles 320 between products using tabs. Each time a product is loaded into 310 with the products name appearing in the fixed tab, a scrolling tab with the products name 321 is added to the scrolling tabs section, 320 where it always remains in context to the other products selected for easy reference and access, and will be removed when the Product Detail Window Pane is closed. The arrows 322 are used for shuttling tabs from left or right as needed to access product tabs that may be out of sight. At step 330 a customer may implement Customer Action Options. In FIG. 10 the customer action options are visible and reviewed in detail as 331-337. At Checkout 400, when a customer clicks “Add to Cart” the product is added, below, on the same page, into the Shopping Cart Window Pane.

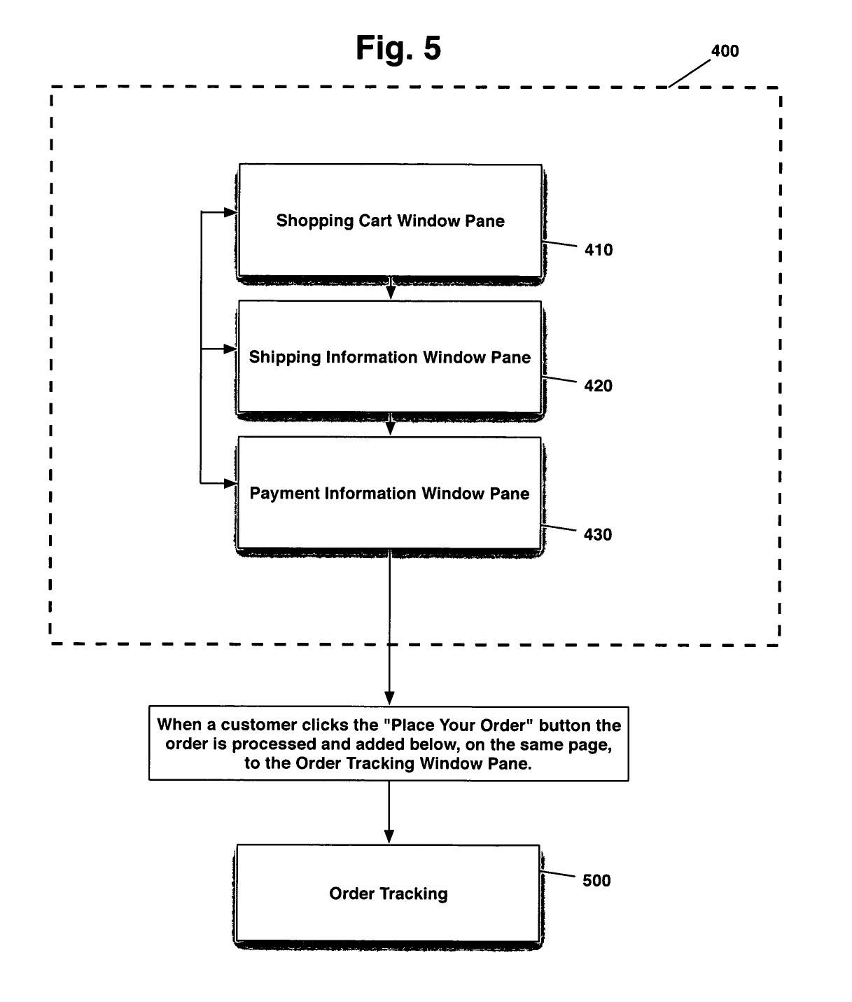

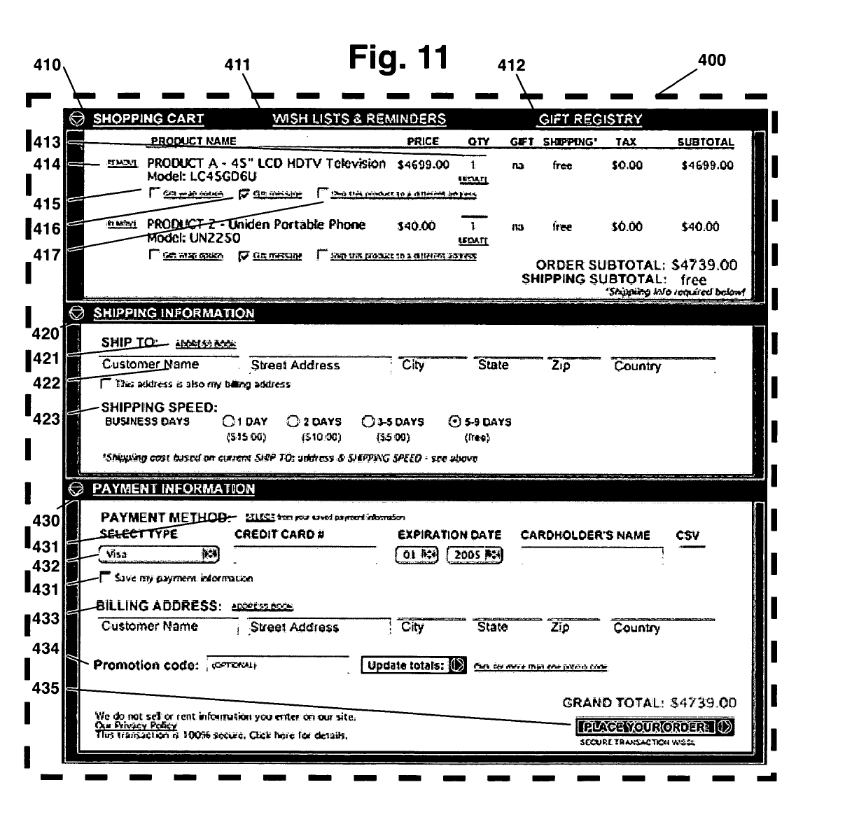

Turing to FIG. 5 Checkout 400 depicts the buying process and it consists of three Window Panes. Shopping Cart Window Pane 410 depicts products added are a collection of items the customer is contemplating for purchase and a few key Customer Action Options include removing an item from the shopping cart or changing the quantity to be purchased. More detail in FIG. 11. The Shipping Information Window Pane 420 includes collecting key information re: ship to: address information and Shipping Speed options. (see FIG. 11.) Payment Information Window Pane 430 includes key data points and functional elements including: Specific payment information, Billing Address information, and Place Your Order button. (See FIG. 11.)

Order Tracking 500 depicts when a customer clicks the “Place Your Order” button, the order is processed and added below, on the same page, to the Order Tracking Window Pane.

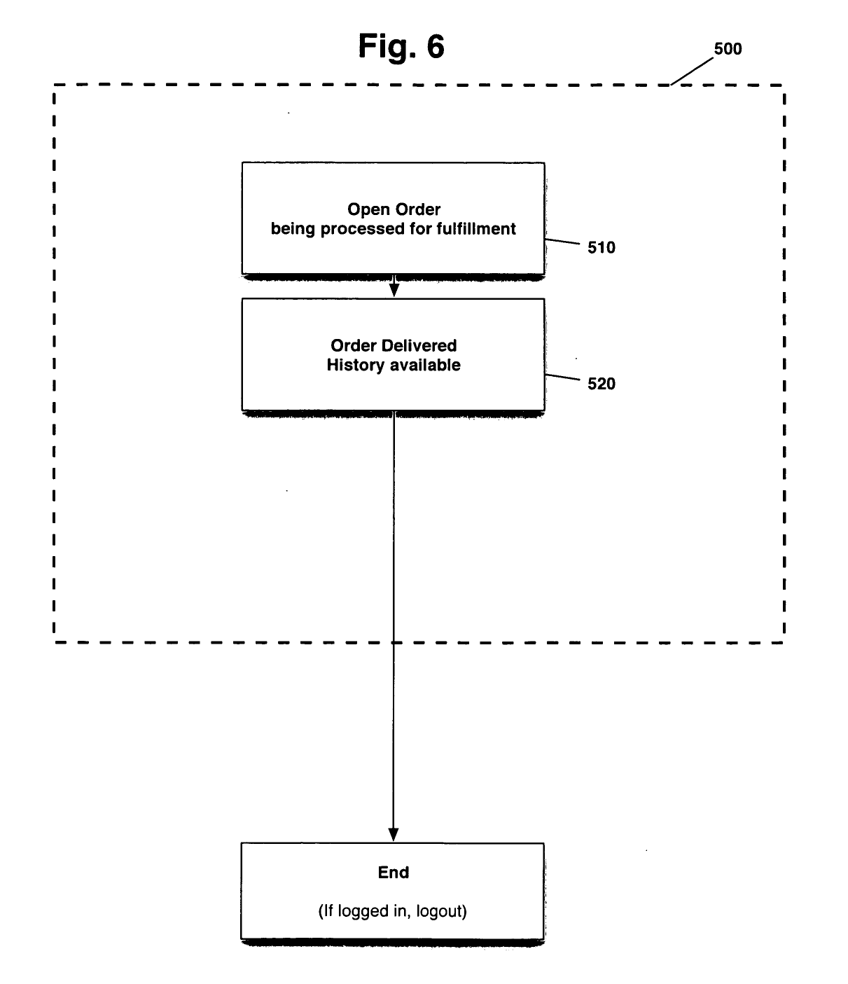

As shown in FIG. 6 Order Tracking 500 depicts where an order is displayed after a customer places the order, with 2 important aspects of Order tracking providing customers to track their purchase based on shipping options and order number. Order delivery confirmation and a history of all purchases. Open Order 510 depicts an order being processed for fulfillment. After an order is placed by a customer an open order status is indicated for the order while the store that made the sale begins processing the physical aspects of the fulfillment process; pulling, packing, shipping, and processing customer payments. The status of the order then changes to “Order Delivered” 520. Order Delivered, History Available indicates the same order changes from being an open order to becoming an order that has been delivered with a history of the sale.

In FIG. 7 a Cascading Menu Search 120 is depicted as a screen shot detailing an embodiment of the invention, for example including Hotspot area 121 which when selected (i.e. a mouse on/cursor rolling over the area) will activate the cascading menu.

Cascading Menu Search 122, 123 is populated by a database 125 and provides organizational cues for customers by using super sets of organizational terms as in; i.e. A super-set of Generic Categories such as “Electronics” or sub-categories such as “Phones”, along with another super-set option of “Name Brands” with a category entry like “Motorola”® or a sub-category like “Phones” known as RAZR, and so on . . . These super sets are established based on what is known about how differently majorities of customers think about finding the same products or categories. The database 125 populated cascading menu allows for a multitude of groupings and nesting of information thereby providing a user a very efficient method for getting significantly deeper to their desired search results without having to scour thru page after page after page.

Turing to FIG. 8 Product Thumbnail Images 210 are loaded and displayed. The search results are returned and displayed on the screen as thumbnail images 201-208, loaded into a Horizontal Browser window 211 whereas a user can drag a slider 214 to view all its contents. FIG. 8 shows results loaded from left to right creating the illusion that the horizontal browser has quickly and fully loaded, while additional images may be loading off-screen, into the computers cache, but not yet visible to the user. It is possible therefore to load hundreds upon hundreds of results to create a satisfying customer experience, helping customers get to the image/product they want significantly faster than other current search result implementations. An area for thumbnail images 201-208 depicts product thumbnail images loaded into thumbnail browser. Horizontal Thumbnail Image Browser 211 is the horizontal thumbnail windowpane where thumbnails are loaded and meta-data gets displayed when requested. Arrows 212 for turning on/off auto-scroll feature. These arrows are buttons for activating or de-activating an auto-scrolling effect which shuttles images to the left or right and images have their meta-data displayed one at a time as the items scroll by the center of the screen. Each products meta-data would stay up on the screen for a matter of seconds. This feature can be paused by rolling over the thumbnails or stopped by clicking on an arrow. Sort by Price button 213 is an option that allows results to be “sorted by price.” Scroll Bar 214 is for quickly scrolling to anyplace within the results set. Sort by Alphabetical order 215 allows a user to sort results by alphabetical order.

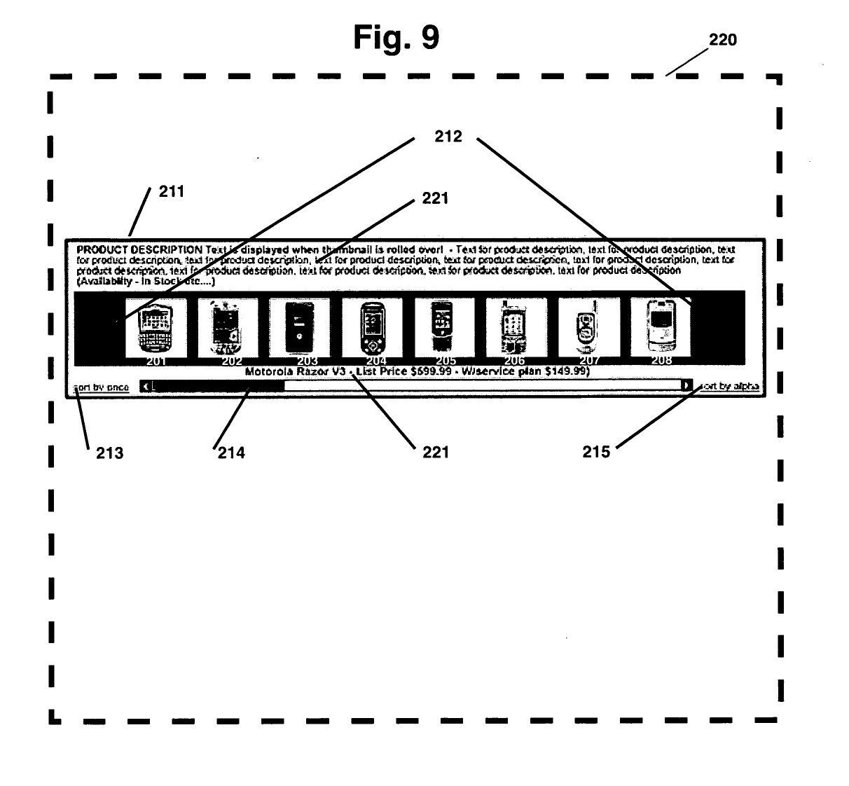

In FIG. 9 Product Thumbnail Images 220 are loaded but not displayed until requested. Thumbnail images are tagged w/associated meta-data about the images content; such that the meta-data 221 is loaded but not displayed until a specific thumbnail is highlighted.

An area for thumbnail images 201-208 depicts product thumbnail images loaded into thumbnail browser. Horizontal Thumbnail Image Browser 211 is the horizontal thumbnail windowpane where thumbnails are loaded and meta-data gets displayed when requested. Arrows 212 for turning on/off auto-scroll feature. These arrows are buttons for activating or de-activating an auto-scrolling effect which shuttles images to the left or right and images have their meta-data displayed one at a time as the items scroll by the center of the screen. Each products meta-data would stay up on the screen for a matter of seconds. This feature can be paused by rolling over the thumbnails or stopped by clicking on an arrow. Sort by Price button 213 allows results to be “sorted by price.” Scroll Bar 214 is for quickly scrolling to anyplace within the results set. Sort by Alphabetical order 215 allows a user to sort results by alphabetical order. Product Meta Data 221 associated with image 203 meta-data includes, Product name, Pricing, Pricing w/Service Plan, and a Brief or Detailed Product Description. Outlining the image in blue denotes it's the product being highlighted and is associated with the meta-data.

In FIG. 10 Products Detail 300 depicts the product data is loaded into the main area of the windowpane w/a fixed tab and reviewed by the customer with several options to take actions provided. With multiple products being loaded one after the other w/each getting its own tab allowing the user to move between products via tabs easily and quickly.

Product Detail Window Pane 310 has a fixed tab and displays product data to merchandise and support sales as is best determined by storeowners. Product Data 311 with a Fixed Tab is where the Windowpane is a flexible and configurable container whose primary purpose is to sell products thru optimal merchandising and providing best available information. It is organized based on a customizable product template and populated by the products data points pulled from a database 125 125. This window needs to contain the product name in the fixed tab at top, a product photo, description and price and may contain many photos, or/and videos along with, quick specification summary/detailed specification, highlighted features section, description, warranty information, owners manual information, post-sales product information, special offers, buying considerations. Up-sell 339 and Cross-sell function depicts where the up-sell and cross-sell function displays products that are related in some way to the product being featured in the Product Detail Window Pane. Selecting a product from this area will open the product in a tabbed product Detail Window Pane.

Horizontal scrolling tabs 320 tabs are labeled w/product names and help customers to easily switch from product detail to product detail while scrolling through all tabs. The scrolling function of tabs is believed to be unique and it allows for an unlimited number of product details to be easily and quickly accessed. Tabs 321 in Scrolling window are created each time a product is selected from the thumbnail search results and the product data is loaded into the Product Detail Window Pane. By clicking on a scrolling tab the associated product is displayed in the Product Detail Windowpane, making it visible in the main product detail windowpane.

Scrolling tab arrows 322 are used to scroll tabs to the left or right. Customer Action Options 330 are for customers to take an action. Email product information 331 to friend button-fill in the form and hit submit, use a comma to send more than one e-mail at a time. Print this Page button 332 depicts where click to print product windowpane with all or selected sections. Save to Wish List button 333 depicts an add a product to a list of products with the option to purchase at a later date. Add to Cart button 334 depicts an add product to list of products to be purchased by clicking this button. Write a Review of this product link 335 is an open a field to be able to write and submit a product review. Read Reviews link 336 depicts a click on the link to read reviews written about this product. Compare products matrix tab button 337 is a button used to open a tab in the product detail windowpane area that displays a matrix of attributes of similar products.

“Does the store nearest me have this item in stock for immediate pickup?” link 338 is an option available for stores w/brick and mortar outlets near you, will check the inventory of the store and if available will give you the option to purchase now and pickup the product at the customer service window. Accessories & Related Products area w/links 339 is a scrolling area of product thumbnail images is to up sell/cross-sell related products which is useful for a customer with each product detail a customer is reviewing.

Turing to FIG. 11 a Checkout 400 is depicted where the buying process or functional processes that take place after the shopping process when a customer has made a decision to buy something and now needs to pay for it. Shopping Cart windowpane 410 is a collection of items a customer had decided to purchase is displayed in a windowpane area. Wish Lists & Reminders Links & Areas 411 depicts points that can be opened up into its own windowpane, below shopping cart area to display a list of products that can be purchased at anytime in the future, pending availability and current terms. While the Reminders link is used for keeping a list of birthdays, anniversaries, etc in a calendar view and will send e-mails or post notifications for users as event dates get near.

Gift Registry 412 can be accessed for someone the customer knows who has created a registry for themselves for their special event so specific preferred gifts are listed and can be purchased, or/and a registry can be created by a customer for their own special event, displaying gifts they would prefer; commonly used for, i.e.; Bridal, Anniversary or Birthday, etc . . . Quantity field 413 depicts where a quantity is inserted. It is common that after an item is placed in a shopping cart, the customer will review the number of items being purchased and may change it. The field is editable, and the order totals will update after a change is made. Remove link 414 depicts a product can be removed from the shopping cart by clicking on this link. The order totals will update after a change is made.

Gift Wrap Option checkbox 415 is where a customer may check the box to have an item gift-wrapped. Gift Message checkbox 416 is where a customer may check the box to then add a message to the product being purchase. Ship this product to a different address checkbox is depicted at 417. The customer has an option to send one or more items to different shipping addresses. If this box is checked Ship to: information fields and Shipping Speed: option will appear directly under the individual product. Shipping will be calculated for each address and the product being shipped.

Shipping Information windowpane 420 contains the following functions for working w/shipping information. Address Book link 421 provides an option to create new, save, edit, import and delete shipping addresses for easy access and re-use. Ship To fields 422 are provided for: customer name, street address, City, State, Zip and Country. There is a checkbox available to use this address to populate the Billing address information fields below. Shipping Speed radio buttons 423 provides options for how quickly a customer wants a product delivered. These options can be customized to coincide with the stores preferred method for shipping.

Payment Information 430 depicts the transaction for the payment will be handled by the store directly via a merchant account or a third party payment processor; i.e. Paypal, Google Checkout, etc . . . Select from List link 431 is similar to an address book this link will provide access to past/saved payment methods; where a user can select one for re-use; or have the option to: add new; edit, or delete entries from the list. Select Type pull down menu 432 shows where it is up to the store to determine what payment options they accept and the user can select from the list and the fields required for the payment type will conform to those requirements.

Billing address fields 433 are provided for: customer name, street address, City, State, Zip and Country. Promotion Code field 434 is an optional field to be used if the store has distributed promotional codes for discounts, etc . . . When a promo code is entered, the system checks for validity and if appropriate, the system updates the Grand Total.

Place your Order button 435 is used to complete a purchase and submit the order for processing the customer must click the button. A confirmation that the order was placed will appear on screen.

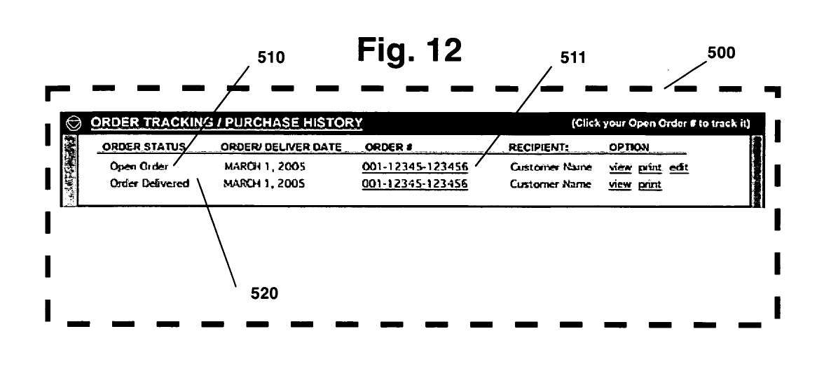

FIG. 12 depicts Order Tracking Services 500 that provides information related to tracking an order from the time it is submitted and then converts the Open Order status to Order Delivered so it can be available for a history of past transactions. Open Order status 510 depicts where a product has been ordered but not yet shipped. The following fields are shown for an open order, including; Order status, Order Date, Order #, Customer Shipping Name and options to View, Print or Edit the order. Edit options will depend on any laws governing online orders and stores policy to make changes after an order is submitted and before it is shipped. Order number link 511 is clickable and will provide detailed summary based on shippers available information as to where the order is in the fulfillment process. Order Delivered status 520 depicts where an order has been delivered and the status is updated to reflect his change. The following fields are shown for an open order, including; Order status, Shipping Date, Order #, Customer Shipping Name and options to View or Print an order. A past order can be resubmitted to Checkout for processing.

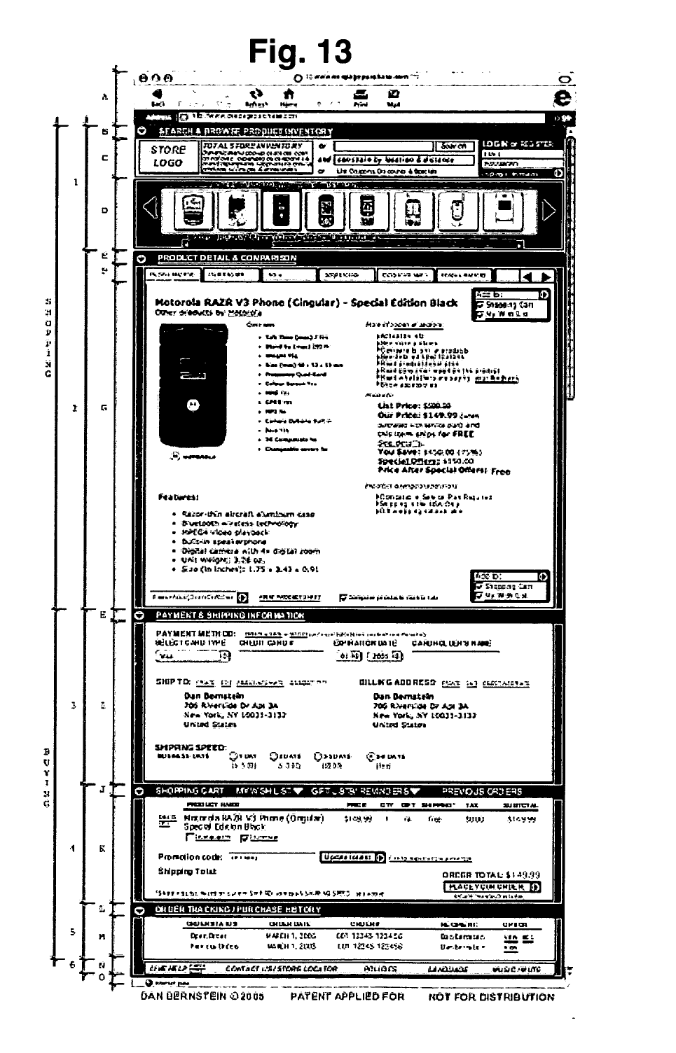

FIG. 13 depicts a screen shot of a One Page Purchase format (that for illustration purposes only, it should be noted that drawing 1 illustrates a logged in state through-out the process, but at the top of the page the login and password fields are still shown—this condition would never exist, after login there would be a customer greeting “Hi Dan” w/access to the customers preferences “my account.”) presented in a browser and having an integrated format. Further, the invention provides for a computer implemented system to search, browse and buy products online which is simpler in construction, more universally usable and more versatile in operation than any known apparatus of this kind.

The present invention provides a new restructuring of the information architecture and design of the shopping and buying process of products online using a computer interface device that has many novel features not offered by the prior art apparatus that result in a new more efficient, easier-to-use way for customers to search a stores inventory, browse to review product details and compare products, and then buy and ship products all in one page, an interface device which is not apparent, obvious, or suggested, either directly or indirectly by any of the prior art apparatus.

The invention may be used by a customer, typically when using the Internet using a standard browser as defined by the open standards defined by the World Wide Web Consortium, w3c.org; and entering a domain name and going to a web site store to shop and buy products; however, (The implementation can be provided in a client-side application configuration, on a “personal computer” “pda” or “mobile phone” which is also a practical version and does not necessarily require a browser, however it still would require a communications network to update current inventory or complete a transaction.) Everything described here takes place on one page and is populated by a database 125 125, typically owned and operated by a company, with an online store.

The page is collapsible and can fit easily into one screen when all sections are minimized as can be seen in (FIG. 13: Sec B, E, H, J, L in an expanded position or in drawing 16: Sec B, E, H, J, L in a collapsed position) the arrow within the circle on each title bar when clicked toggles to open up the section, thus allowing a customer to close or open only those sections they are working on at the time.

When viewing the invention the user sees search & browse utilities organized in a horizontal section along the top of the screen, (FIG. 13: Sec C.) SEARCH & BROWSE PRODUCT INVENTORY. These utilities are customized for a specific stores need and merchandising sensibilities and business requirements:

A keyword search term is available to search the database 125 for matches of name, description etc. which will return results that are either; null or if more than one result is found will be displayed below in the thumbnail browser or if a direct match of only one product is found then the specific product detail will be displayed below in the tabbed product detail area.

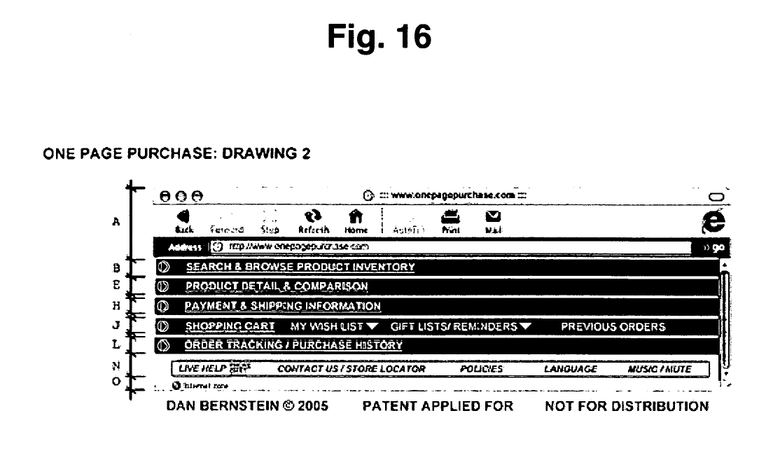

The primary method for locating products is a database 125 generated dynamic drop-down cascading menu, (FIG. 16: center of drawing) which opens when rolled over w/mouse/pointer and provides, in text, photos optional, a stores total available inventory, allowing a customer to move from general categories or departments to specific products by name or attribute.

As an example a store might carry a diverse group of products; i.e. cell phones, dishwashers and cars, in which case:

A rollover of the inventory menu displays level 1 and cascades open to display the major categories and the option to rollover and highlight one, either: cell phones or dish washers or cars; w/cell phones selected by rollover, level 2 cascades open to display a sub-category of options: phones or accessories or service plans; w/phones selected by rollover level 3 cascades open to display options for: Brands or Phones by Carrier or Phones by Type and whichever is selected by rollover will cascade to the next level of detail listing the specific product grouping. The customer can now make their selection of a group of products by clicking on the selection; which will populate the thumbnail browser w/images below; or else select a specific product from the next level of the cascading menu and have that products detail page show up below, bypassing the thumbnail browser strip.

If it is a group of products that are available this array result set will show up in the next horizontal section of the interface, (FIG. 13: Sec D.) which will populate w/thumbnail images of all products in the results. The user can roll over the images or scroll to see more product images to the left or to the right; rolling over a product will display the products meta-data-name, price and description on the screen, while rolling off of the image will make the meta-date information disappear. By clicking on a product image the products detail will be called from the database 125 and be displayed below in the profile area containing a fixed and a scrolling tab of its own. The number of product images that can be loaded is dependent only on limitations of a customer's preferences typically determined by bandwidth or systems limitations; but 200 images are easily downloaded on standard connections w/acceptable latency periods. This menuing system and thumbnail browser are designed to make it easy for a customer to find products in an inventory with virtually no limits on size, except those by the system.

The next horizontal section of the page is (FIG. 13: Sec G.) PRODUCT DETAIL & COMPARISON and it contains the products detail descriptions, photos, pricing, terms along with a tab and the opportunity to add the product to the (drawing 13: Sec K.) SHOPPING CART.

There are 2 types of tabs (FIG. 13: Sec F.) with one being a fixed tab that displays the current product being viewed by the customer along with a scrolling tab for easy access to those products being considered for comparison to each other. This scrolling tab system is unique and allows for an unlimited number of tabs to be open at one time, with arrows at one side the tabs can be scrolled left and right easily. Tab order can be re-arranged by dragging and dropping them within the linear sequence and clicking on the current or fixed tab will call it's scrolling tab adjacent to it; providing the option to close the tab.

All of the activities by the customer up till now have been part of the shopping experience and they do not require the customer to be logged in; however the next steps are about buying and an account is required for both; to make a purchase and to remember the customers state for when they return. The “state” is the condition of all elements on the page as the customer left them prior to logging off.

The next horizontal section is (FIG. 13: Sec I.) the PAYMENT & SHIPPING INFORMATION, which is required from the customer prior to successfully placing an order. This section contains payment information, ship to: details and billing address: information, along with an option for shipping speed w/dynamic pricing based on ship to information and products being shipped.

The next horizontal section is (FIG. 13: Sec K.) the SHOPPING CART that contains all the products selected for purchase in this session. Products are listed and include additional options like quantity that can be edited or gift-wrapping options. Other line items in this section include optional promotion code line and a line for the shipping and tax information. A customer can see their order total and, when ready, place their order. A confirmation will appear and their order will become an open order until the products are delivered.

The next horizontal section is (FIG. 13: Sec M.) the ORDER TRACKING/PURCHASE HISTORY that provides access to both; recently placed open orders and previous orders that have been fulfilled.

The foregoing has outlined, in general, the physical aspects of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

In an embodiment the invention may provide a significantly improved customer experience by reducing or removing completely the destructive page refresh by placing all functions, processes and procedures required to start and complete the shopping and buying process on one page that will overcome the deficiencies of the prior art devices.

In an embodiment the invention may provide a dynamic, database 125 generated, drop-down cascading menu that opens on a rollover; containing the stores product inventory, organized by categories/brands/departments/attributes displaying all products from one menu device that provides easy and direct access to every single product the online store has for sale.

In an embodiment the invention may provide a horizontal thumbnail image browser which displays large numbers of ‘photos or images of products or brand logos’ in groups based on the results from either; the text search, or, the dynamic drop-down cascading menu) device that will allow users to load and easily scan thru, several hundred images, which is many more times the number of search results than traditional search engines are returning in their results array; thereby allowing the customer to quickly find what they want.

In an embodiment the invention may provide a scrolling tabbed system to support the selecting of many products from the thumbnail image browser a device that allows an unlimited number of products to be chosen for closer inspection of their product details and comparison to similar products.

In an embodiment the invention may provide a scrolling tabbed system that allows tabs to be dragged and dropped so that product detail pages can be arranged by tab to be placed near each other as a customer preference for easy comparison of like products.

In an embodiment the invention may provide a checkout process in a horizontal section on the same page as the searching, browsing and product comparison) device that allows customers to easily make changes at anytime during their shopping experience, without the dread of losing all of their saved information by going back to review product details or add another product.

The present invention pertains to a computer implemented system for a consumer to purchase products online by offering all of the steps required in the shopping (search, browse, review product details, compare products, add to cart) and buying (checkout; bill to info, ship to info, order placement, confirmation, tracking) processes into a “One Page Purchase format” machine interface design used across a communications network, of which the following is a specification:

The purpose of the One Page Purchase format is to increase sales by improving the merchandising of products and improving the customer experience by simplifying the searching, browsing and buying of products in an online store; the “One Page Purchase format” will:

A. In “One Page”, make it simpler than it is today to, find any product in a company's inventory, review its details and complete the buying process and avoids completely or minimizes destructive page refresh.

Destructive page refresh happens when a new page is loaded into a browser and this happens several times in a typical website store. Destructive page refresh: disrupts continuity of experience and disorients users from their visual context within a multi-step process disrupting their train of thought. In the shopping or buying process the back button is used several times to reload previous pages requiring the destructing of the current page.

A portion of the disclosure of this patent document including the drawing figures and screen shots contains material that is subject to copyright protection. The copyright owner has no objection to anyone reproducing the patent disclosure as it appears in the Patent and Trademark Office patent files or records. However, the copyright owner strictly reserves all other copyrights.

B. View large quantities of search results that are images or photos and their meta-data in a format, horizontal side scrolling browser window that is easy to use.

C. Open an unlimited number of tabs that are always available via a horizontal side scrolling browser.

D. Reduce abandoned shopping carts during the online shopping process prior to completing the buying process.

E. Support a non-linear shopping and buying experience, in large part by having all processes on one page and not needing to use the back button.

F. Provide information architecture for efficient electronic commerce shopping commonly known as searching, browsing and Shopping Cart activities and for efficient electronic commerce Buying, commonly known as Checkout consisting of shipping, billing and order placement activities.

G. Provide useful Internet commerce tools through a unique modular graphical user interface design, available on one page that is organized in a precise relationship grouped into the following processes. (see items b, e, h, j, l on both FIG. 13 and FIG. 16).
b. SEARCH & BROWSE PRODUCT INVENTORY
e. VIEW & COMPARE PRODUCT DETAILS
h. PAYMENT & SHIPPING INFORMATION
j. SHOPPING CART and PLACE ORDER
l. ORDER TRACKING/PURCHASE HISTORY

The One Page Purchase format design can be joined to an existing online store to provide an alternative way to shop and buy products or the design can be used for a small company's online presence and can be used as the entire web presence or as a section of the website containing the store. The costs for maintaining the One Page Purchase format will be more cost effective than traditional websites.

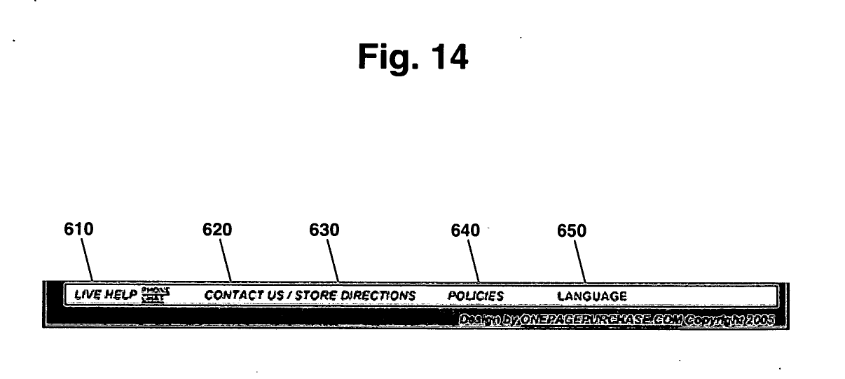

FIG. 14 illustrates the footer elements common for many stores. The links shown in this figure are as an example of possible services available by the Live Help link 610. A store may provide Phone or Chat customer service access. The Contact Us link 620 depicts where a store would provide preferred methods of communication here. E-mail forms, phone number and physical address would all be appropriate methods. Store Directions link 630 would be used for an online store that also had Brick and Mortar store locations. Policies link 640 depicts where stores policies can be listed. Language pull down menu 650 depicts where a store could implement a multi-language store and would provide access to the supported languages here.

FIG. 15 shows a screen shot of an alternate embodiment of a One Page Purchase format 10, which could use a browser, but is not shown in a browser here; also shown are more modifications including an area added for “Accessories & Related Products”

FIG. 16 illustrates the windowpanes in a closed position. Each could be in an open or closed state at any time in the shopping/buying/tracking process, based purely on customer preference. FIG. 16 is a screen shot view of a one page purchase format illustrated with all sections collapsed by the user according to the present invention.

FIG. 17 depicts a System Relationship Diagram that depicts an embodiment of the present invention. While hardware and software continues to change and evolve, today's standard technologies can be applied to implement an integrated format page such as One Page Purchase format 10. Software coding implemented today may utilize either: A.) AJAX—Asynchronous JavaScript and XML; or B.) Flash a proprietary software that has become a standard in the industry. Both coding procedures and techniques help to do away with “destructive screen refresh” by only changing those elements on the screen that require an update; today each click typically erases the entire screen and requires reloading and redrawing the screen display for the user to continue their work. Another important technical consideration, also well established by today's standards, is the use of ssl or tsl chryptographic protocols for securing the transmission of personal and financial data when being transferred by the customer on the Client Side over the internet to the Server Side for submission, saving, approval and processing.

The major components required for One Page Purchase to operate, include a Client Side Computer System 10. The user must have a current computer system and the typical embodiment would utilize an internet browser. Also required is an internet connection and network 11. The network of computer systems form the backbone which provide access for both Sellers and Buyers to perform transactions. Finally, a Database 125 is required or multiple databases provide storage for product and customer data and the purchases completed online.

Other components may include Server Side hardware and software including Server Side software code and Client Side hardware and software, including a web browser running on a computer with Internet access. While hardware and software continues to change and evolve, today's standard technologies can be applied to implement an integrated format such as a One Page Purchase format 10.

Optional Deployable Embodiments include One Page Purchase format that can be launched as a client side application or from within a browser with either embodiment requiring access to the Internet.

A market channel application deployments may be provided where One Page Purchase format can be deployed into the market place in a variety of methods, for example: 1) A company web store that has implemented One Page Purchase format loads the stores inventory of products organized by categories & brands into the dynamic database 125 populated cascading menu element; when a customer makes a selection One Page Purchase format will search and return product results based on availability; while Small mom_and_pop.com stores or large companies with online stores like Amazon.com, Nike.com or Sony.com are examples of this type of implementation. 2) An Application Service Provider, ASP, company would contract and license One Page Purchase format as a turnkey template for their online On Demand software “shopping and buying” services which they license or sell to others. The company's customers would have online stores that utilize the company's backend software; and they would be provided under agreement with an option to turn on ONE PAGE PURCHASE FORMAT for their ASP stores customers. 3) Internet Search Engines are utilized to help find products available for sale online. A search engine company would use the free form text field or Boolean search parameters to search the internet or load a generic set of super-set categories, sub-categories and products into the dynamic database 125 populated cascading menu element, FIG. 7.; when a customer makes a selection on a ONE PAGE PURCHASE FORMAT will do an internet search for all products whose companies have made their products available for online search and sale and display those in the search results area.

Alternate application embodiments include a One Page Purchase format that is shown in this embodiment to be used for purchasing products, since this is a more complex application and includes the checkout/payment process; while the One Page Purchase format components referred to herein in FIG. 1. as 100-Product Search and 200-Search Results and 300-Products Detail could be applied to other industries where buying is not the end goal and therefore FIG. 1. 400-Checkout and 500-Order Tracking are not applicable; for instance online dating would be made greatly more efficient/easy for users if the Search, Results and Profile elements were organized as presented here using One Page Purchase format; Or, else in the case of a library where the end result is not a purchase so to speak but all the steps in achieving the customers goal can better be realized through using One Page Purchase format.

Login Options may include a system where a customer does not need to be logged in while shopping; however customers who create an account and do login will have access to certain functions, like “My wish list”, Address Book, Purchase History, etc . . .

It will also be understood that, in addition to the One Page Purchase format process, the device can be used to search for images of any kind; including photos of people or for art, photography archives, science; i.e. for finding photos of people in a dating site or for use in a government database 125 of those to “Be On the Lookout” for, in other words, the buying process is not always required to get the benefits of the searching, thumbnail image browser and tabbed system design.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

1. A computer implemented system for organizing information in a computer comprising:
a product data area for aggregating data for products;
a completed order area for collecting the product data for multiple products and providing options for handling the products as a completed order and providing completed order data;
a delivery area for determining delivery options for the completed order and providing delivery data;
an order tracking area for tracking the completed order and providing order tracking data;
a display system for displaying each of the product data, completed order data, delivery data and tracking data substantially in an integrated format.

2. The system of claim 1 wherein the integrated format includes data transfer means for processing data collectively from the each of the product data, completed order data, delivery data and tracking data and displaying all such data in a single page format.

3. The system of claim 1 wherein the integrated format provides for a display of data so that during selection of the data, each previously selected piece of data may be continuously displayed during selection and display of subsequent data.

4. The system of claim 1 wherein the integrated format allows for display of data in a plurality of window panes and where an integrated sequence of inputs may be processed without destroying previously selected data.

5. The system of claim 1 wherein the product data area includes a product search engine which allows for the searching of multiple products from a database by category.

6. The system of claim 5 wherein the product search engine includes a keyword search function.

7. The system of claim 1 wherein the product data area includes a product search engine which includes a cascading menu search depicting multiple products searched from a database.

8. The system of claim 1 wherein the integrated format allows for completing an order by a computer enabled system by providing completed order data, delivery data and order tracking data with four or fewer input actions.

9. The system of claim 1 wherein the product data area displays search results by loading product images and allowing the customer to view images propagated in a window pane depicting the search results in a horizontal row.

10. The system of claim 1 wherein the product data area includes a product detail section which includes horizontally arrayed product tabs which designate individual products that allows users to toggle between the product tabs so that the customer may implement customer action options.

11. The system of claim 1 wherein the completed order area includes a shopping cart window pane, a shipping information window pane and a payment information window pane each accessible from a browser.

12. The system of claim 1 wherein the order tracking area includes an open order function and an order delivered function in order to display the status of the product to be delivered.

13. The system of claim 1 where each of the completed order area, delivery area and order tracking area are maintained on a computer server which is connected via the Internet to an end user's computer which displays the product data, completed order data, delivery data and order tracking data on a single page so that the end user may view all of such data by scrolling up or down the same page.

14. The system of claim 1 where the product data is displayed in a first window pane, the completed order data is displayed in a second window pane, the delivery data is displayed in a third window pane and the order tracking data is displayed in a fourth window pane and the modification of data in one of the first, second, third or fourth window panes may affect the modified display of data in one of the first, second, third or fourth window panes without requiring the computer to refresh the display or destroy a previous display.

15. A page information display method for displaying electronic information including the steps of:
displaying product data in a first window pane;
displaying completed order data in a second window pane;
displaying delivery data in a third window pane;
displaying order tracking data in a fourth window pane; and
displaying the first, second, third and fourth window panes on a single page and providing for integration of each of the first, second, third and fourth window panes so that data entered into one of the first, second, third or fourth window panes may automatically be updated in one of the other of the first, second, third or fourth window panes without requiring the display to be refreshed.

16. The method of claim 15 wherein the product data area is filled with data by displaying a scrollable horizontal display of multiple product images.

17. The method of claim 15 wherein the product data area displays information from the product image area by displaying a single product including product details and above the product detail area including multiple tabs that correspond to the multiple product data images displayed in the first window pane.

18. The method of claim 15 wherein the integrated format provides for the step of collapsing each of the window panes into a single line including a header which may be activated in order to expand each of the first, second, third and fourth window panes.

19. The method of claim 15 wherein the first pane includes multiple cascading windows which may be opened in order to display product details.

20. A machine-readable medium having data stored thereon representing sequences of instructions which, when executed by a computing device, causes said computing device to process a customer purchase request over a computer network by performing the steps of:
receiving an online selection request for a first item over the computer network;
retrieving pre-stored product data from a database;
generating a product data description in a first window pane;
retrieving delivery data relating to the product;
generating a delivery data display area in a second window pane;
retrieving order tracking data from a database;
displaying the delivery data in a third window pane; and
integrating the window panes in order to provide for a system that allows for updating of data in one of the first, second or third window panes without requiring the displayed page to be reformatted.
